(19) United States
(12) Patent Application Publication
(10) Pub. No.: US 2018/0343786 A1
(43) Pub. Date: Dec. 6, 2018

(54) LOCKABLE JOINT FOR A TOOLBAR

(71) Applicant: Bazooka-Farmstar, LLC, Washington, IA (US)

(72) Inventors: Eric Svenby, Washington, IA (US); Phillip Minino, Washington, IA (US)

(21) Appl. No.: 16/000,100

(22) Filed: Jun. 5, 2018

Related U.S. Application Data
(60) Provisional application No. 62/515,773, filed on Jun. 6, 2017.

(51) Int. Cl. A01B 76/00; A01B 73/04

(52) U.S. Cl. CPC A01B 76/00; A01B 73/044

(57) ABSTRACT

The present invention includes one or more alignment devices connected to an agricultural implement. The alignment devices are preferably attached, or part of a toolbar, which in turn is connected to, or a part of, the implement. A working unit bar includes one or more working units, such as manure injectors, discs, rakes, or the like. The working unit bar is connected to the toolbar or implement at a joint, where the joint is freely moving at times and held in place at other times. The one or more alignment devices have two modes, storage and operational modes.

### CLAIM OF PRIORITY

The present application claims the benefit of U.S. provisional application 62/515,773, filed on Jun. 6, 2017, which is incorporated by reference.

### FIELD OF THE INVENTION

The present invention relates to a lockable joint for use with an agricultural implement.

### BACKGROUND OF THE INVENTION

Joints connect working unit bars to a toolbar or agricultural implement and are used to permit the working unit bars, and the connected working units, to move when the agricultural implement is in an operational mode. Known joints lack the ability to place the working unit bar into a storage mode. In particular, for toolbars that include wings that are folded during travel and/or storage, the joint and the working units on the wings may move, causing the working units to contact each other or the ground. This is a safety concern as well as causing damage to the working units.

### SUMMARY OF THE INVENTION

The present invention includes one or more alignment devices connected to an agricultural implement. The alignment devices are preferably attached, or part of a toolbar, which in turn is connected to, or a part of, the implement. A working unit bar includes one or more working units, such as manure injectors, discs, rakes, or the like. The working unit bar is connected to the toolbar or implement at a joint, where the joint is freely moving at times and held in place at other times. The one or more alignment devices have two modes, storage and operational. In the storage mode, the alignment device decreases, or eliminates, the space between the toolbar and the working unit bar, called the extended position. In the extended position, the alignment device contacts the working unit bar to hold the working unit bar in place, and prevents the joint from moving. This locks the joint in place and puts the working unit bar in a storage mode. In the operational mode, the alignment device is in its initial state, such that there is space between the toolbar and the working unit bar. This is called the retracted position. In the retracted position, the alignment device does not contact the working unit bar, and permits the joint to move. This puts the working unit bar in an operational mode.

### BRIEF DESCRIPTION OF THE DRAWINGS

FIG. 1 shows an oblique view of a toolbar with four working unit bars, each having two working units attached, where the alignment devices are in operational mode while the implement is turning.

FIG. 2 shows a top view with the alignment devices in the operational mode.

FIGS. 3 and 4 show a bottom view of a pivot joint connecting a single working unit bar to the toolbar, and without the working units, with the preferred alignment devices being extended and retracted, respectively.

FIG. 5 shows a top view with the alignment devices retracted and the implement is turning.

FIG. 6 shows a bottom view of the toolbar with the working unit bars in storage mode, without the working units attached.

FIG. 7 shows an oblique view of the underside of a pivot joint connecting a single working unit bar to the toolbar, and without the working units.

FIG. 8 shows a toolbar with segments or wings, having working unit bars, folded up for storage.

### DETAILED DESCRIPTION

The invention includes one or more alignment devices and one or more joints connecting working unit bars to an agricultural implement.

The one or more alignment devices are preferably part of, or connected to, a toolbar or the implement. For simplicity, toolbar is used to refer to the preferred location of the alignment devices, regardless if the toolbar is separate or integral to the agricultural implement. The alignment devices may be oriented generally parallel to the plane of the ground and generally parallel with the transmission of the implement or the forward direction of travel of the implement. The alignment devices each include a push pad that will impinge upon one or more working unit bars or a portion of the working unit bars, such as a mounting plate.

The one or more joints connect the toolbar to the working unit bar(s). The joints preferably allow rotation about at least one axis that is generally perpendicular to the plane of the ground. That is, the joints allow the working unit bar and the attached working units to move in a plane that is generally parallel to the plane of the ground when the toolbar and/or working unit bar are in the operational mode. Furthermore, the joints are not required to permit movement through a full circle in the plane; rather only a restricted amount of movement of the working unit bars is needed. This restricted movement may be provided by the joint per se, by stops on the working unit bars and/or the toolbar, and, of course, by the alignment devices. Such restricted movement about the joints prevents working units from colliding with adjacent working units, the working unit bars, and/or the toolbars.

Preferred joints include single axis pivots, multi-axis pivots, slide joints, with single axis pivots being more preferred. Single axis pivots generally only allow movement in the form of rotation about a single axis. When utilized, single axis pivots allow the working unit bar and the attached working units to sweep through a plane that is generally parallel to the plane of the ground when the toolbar and/or working unit bar are in the operational mode. As discussed above, movement may be restricted to accomplish the goal of preventing damage to the working units, etc. Multi-axis pivots allow a greater number of degrees of freedom of movement, but otherwise at least allow the same type of movement of the working unit bar as the single axis pivot. Slide joints may also be used to connect the working unit bar to the toolbar. A slide joint includes a pin that is held within a slot, preferably an arcuate slot, such that the pin is movable within the slot, typically providing side-to-side movement, and some amount of rotation if the slot is arcuate. Here, the pin is part of the working unit bar and the slot is part of the toolbar or vice versa.

In the preferred embodiment seen in the Figures, a toolbar 10 is preferably used to connect one or more working units 12 to the implement (not shown). The one or more working units 12 are part of, or mounted to, a working unit bar 14 with a plurality of working unit bars being preferably attached to the toolbar at a joint. For each working unit bar 14, one, two, or more alignment devices 16 are located on the toolbar 10 and associated with a particular working unit bar. For working unit bars 18, 20 located at either end of the toolbar, or either end of a section of a toolbar, only a single alignment device may be needed. Working unit bars 18, 20 are termed exterior working unit bars, while working unit bar(s) 14 are termed interior working unit bars. Each working unit bar is connected to the toolbar at a joint 22 that permits the working unit bar to rotate about an axis 24. Each alignment device includes a push pad 26 to impinge on the working unit bar or a portion thereof.

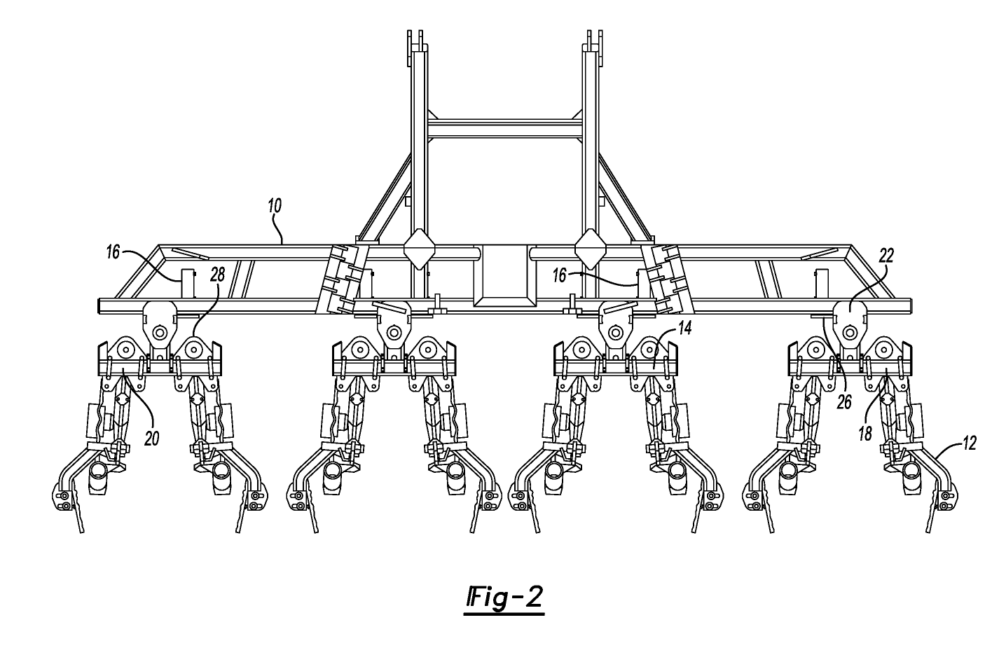

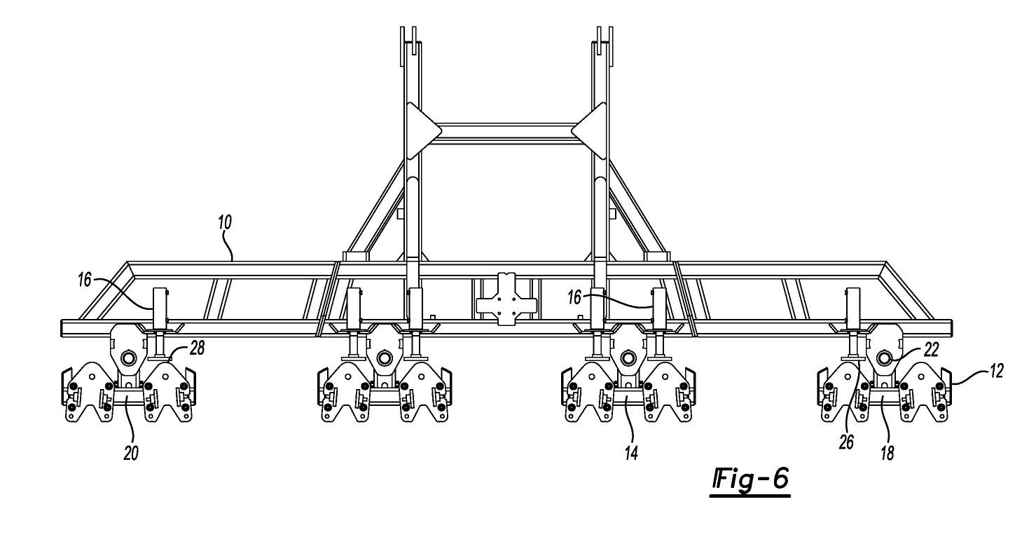

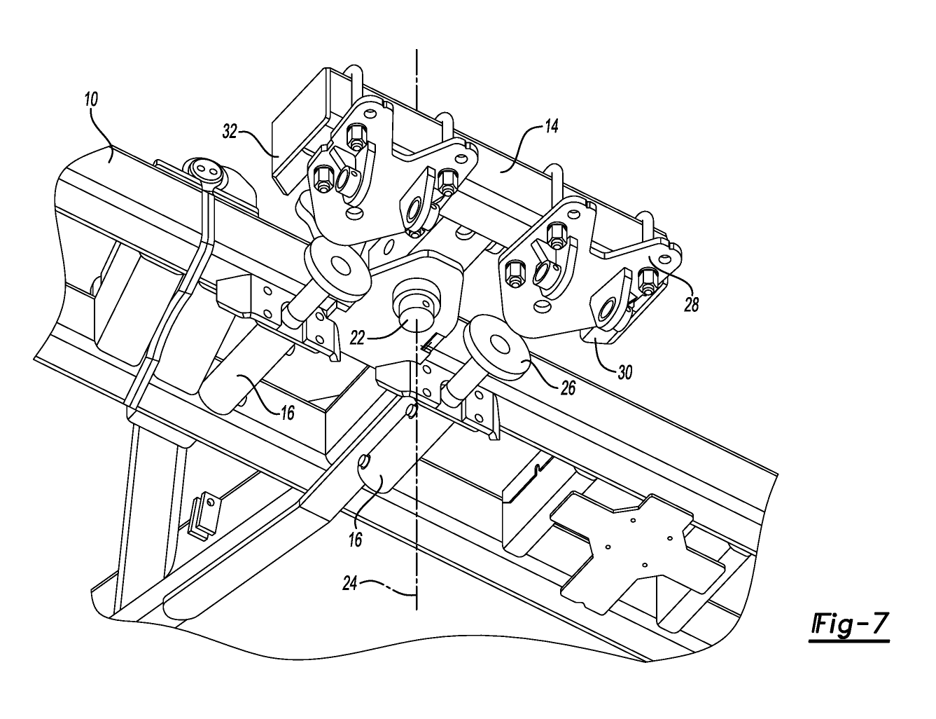

As seen in FIGS. 2-8, in a preferred embodiment, each working unit bar 14 includes at least one mounting plate 28, such that each alignment device mounted on the toolbar is associated with a mounting plate. On the contrary, each mounting plate is not necessarily associated with an alignment device. One or more working units are then mounted to a working unit bar by a single mounting plate. The mounting plate serves the dual function of connecting the working unit(s) to the working unit bar as well as being the location where the alignment devices impinge the working unit bar. This is preferable because differently shaped mounting plates may be desirable for different working units. For example, the mounting plate for a disc tiller working unit may be different than a mounting plate for a manure injector. Also, the mounting plate separates, and thus helps to protect, the working units from the alignment devices.

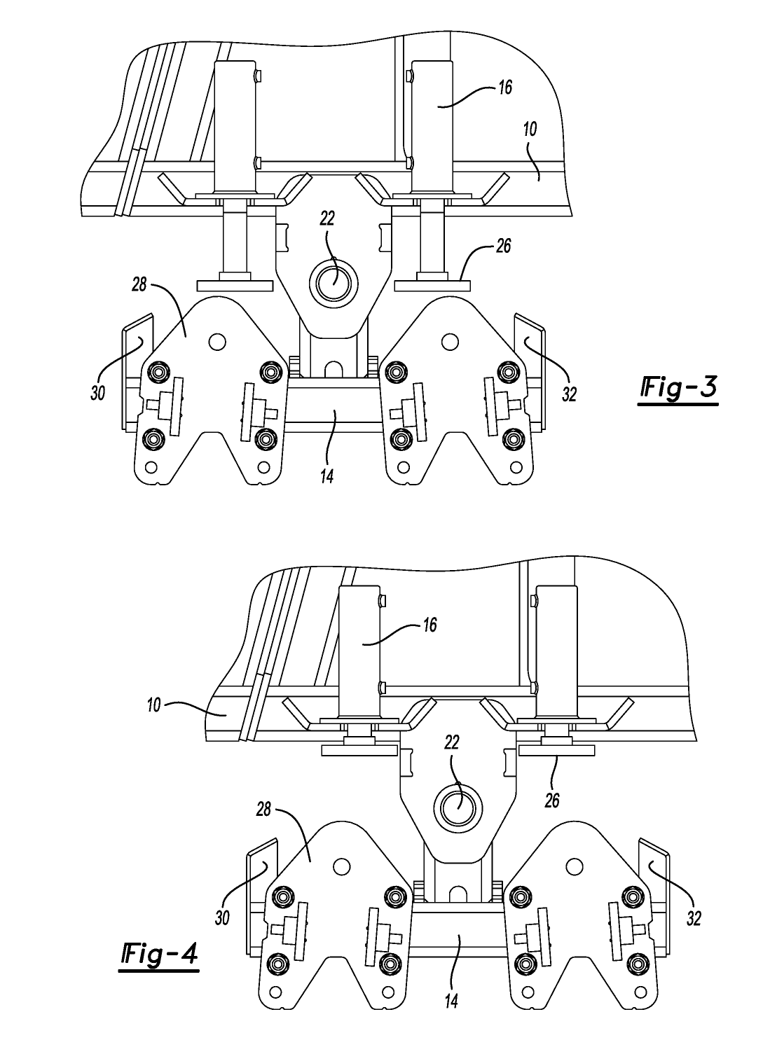

Each working unit bar may also include one or more stops 30, 32 located at the ends of the working unit bar, as seen in FIGS. 3, 4, and 7. The push pads of the alignment devices may also act as stops. Further, stops may be located at other locations, for example, on the toolbar. Generally, the stops, whatever their nature, prevent working units from becoming damaged by contact with each other when the turning radius of the implement is too small.

Any alignment device that accomplishes the functionality of locking the joint in place is contemplated; that is, any device then can increase or decrease the space between the toolbar and the working unit bar and hold that position without otherwise biasing the working unit bar. That is, alignment devices are able to maintain both retracted and extended positions. Preferred alignment devices include ram style and lever style devices. Ram style alignment devices are those that increase and decrease their length. Lever style alignment devices are those that move a lever or arm from adjacent the toolbar (i.e. the retracted position) to contacting the working unit bar (i.e. the extended position). For example, an arm attached to the toolbar at a pivot could be rotated about an axis to contact the mounting plate. Such rotation preferably about a single axis, but is otherwise unconstrained. In this manner, a push pad on the arm would contact the mounting plate in the storage mode to limit movement of the working unit bar. In another embodiment, the arm may include a pin that is held within a hole in the mounting plate in the extended position to additionally secure the alignment device to the mounting plate. Other types of connections between the push pad of the alignment device and the mounting plate are contemplated as well, regardless if a ram style or level style alignment device is utilized.

Actuation or driving of the alignment device could be accomplished with numerous different methods, such as using hydraulic or pneumatic pressure or electric motors to operate the alignment devices. More preferable alignment devices include cylinders such as hydraulic or pneumatic cylinders, with hydraulic cylinders being most preferred because hydraulic systems are commonly used on implements and toolbars to control and operate working units, toolbars, and segments. In one embodiment, in addition to slip cylinders, a rotational cylinder may be used such that the ram rotates about an axis parallel to the longest length of the alignment device as it is being extended or retracted

Each alignment device 16 has at least two positions, extended (FIG. 3) and retracted (FIG. 4). In the extended position, the push pad 26 of the alignment device is located immediately adjacent to or impinging on the working unit bar or the mounting plate 28 of the working unit bar 14. This is referred to as the storage mode. For working unit bars associated with two alignment devices, the alignment devices lock the joint into place and prevent the joint and working unit bar from rotating or swiveling about the pivot joint. This storage mode keeps the working units on adjacent working unit bars from contacting each other during storage e.g. during travel. Preferably, in the storage mode, the joint is locked into a neutral position, such that both alignment devices are extended to roughly an equal amount. However, this is not necessarily the case, and the alignment devices could be extended or retracted to amounts independent of each other.

For working unit bars associated with one alignment device, the locking of the joint is achieved by the alignment device limiting the permitted amount that the joint, and the working unit bar, may rotate or swivel. That is, in one embodiment, the joint may only swivel through a portion of its arc of rotation. In another embodiment, a single alignment device, in the extended position, prevents any movement of the joint by connecting to the mounting plate or working unit bar and holding the joint in position. In these manners, the single alignment device prevents the working units on working unit bar from contacting the working units on the adjacent interior working unit bar. While a single alignment device is preferably used with exterior working unit bars, single alignment device may also be used with interior working unit bars.

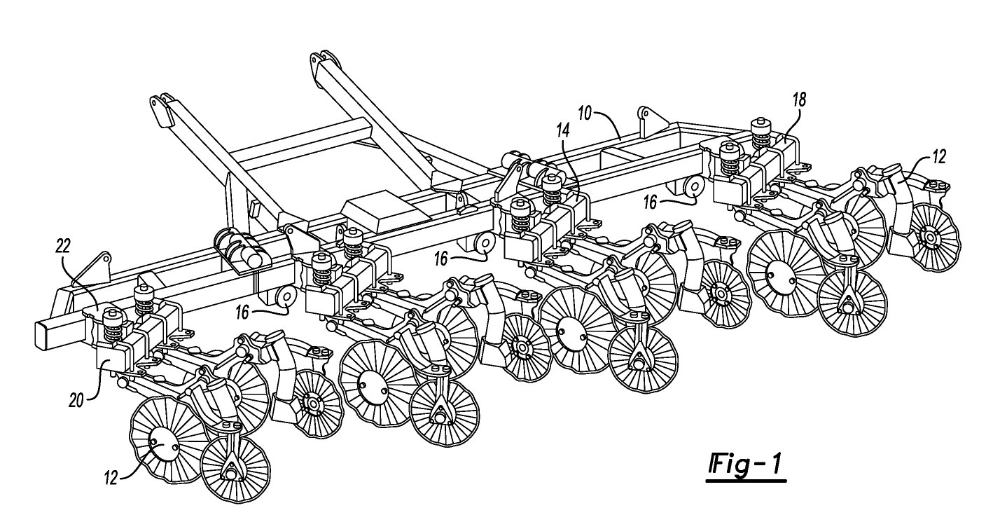

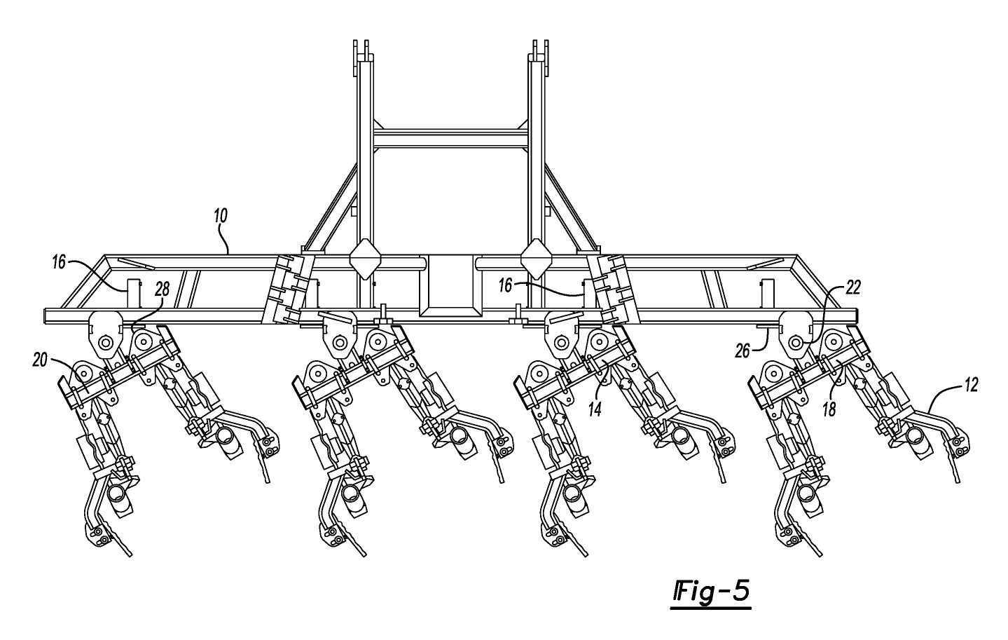

In the retracted or initial position, the push pad of the alignment devices does not impinge or otherwise interfere with the working unit bar. This is referred to as the operational mode because the joint is permitted to rotate or swivel as the implement moves through the field. The alignment devices do not bias or apply pressure to the working unit bar in the operational mode; rather the working unit bars freely move side-to-side on the joint up to the point when it encounters one or more stops, such as when the stops 30, 32 on the working unit bar 14 contact the alignment device or toolbar. The push pads of the retracted alignment devices may also act as stops to limit the side-to-side movement of the working unit bars. This is seen in FIGS. 1 and 5.

While the alignment devices are preferably mounted on the toolbar or agricultural implement, the alignment devices may also be mounted on the working unit bar, such that the push pad impinges upon the toolbar/implement in the storage mode. In such embodiments, the stops would preferably be located on the toolbar.

In addition to the use of the alignment devices to place the working unit bars into storage mode, one or more locking devices may be used to further secure the toolbar, toolbar segment, working unit bars, and/or working units in order to prevent or limit damage during storage. For example, latches, hasps, cotter pins, tumbler locks, etc. may be used to provide redundant protection or otherwise prevent unauthorized use or removal of working units, working unit bars, and/or toolbars.

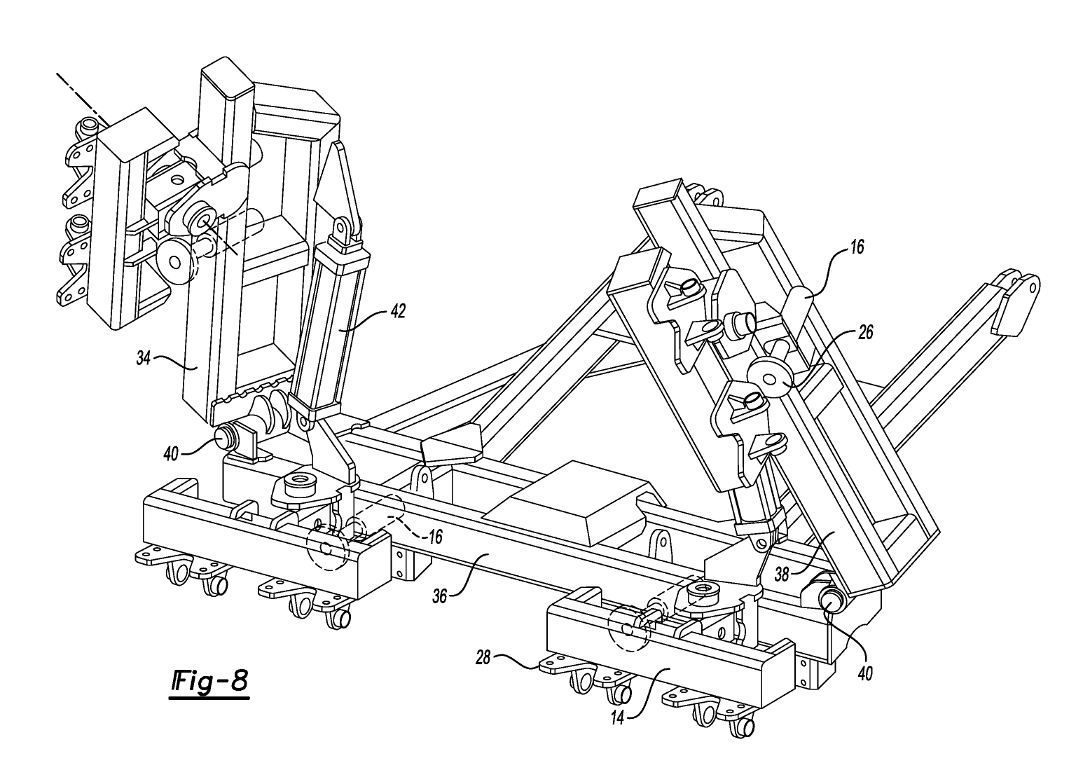

In one embodiment, shown in FIG. 8 the toolbar includes a plurality of segments 34, 36, 38. This permits a single implement to utilize a larger number of working units and thus cover a larger area in a single pass through a plot of land. Typically, three segments are utilized with a middle segment 36 and two end segments 34, 38, where the middle segment is attached to, or part of, the implement, and the end segments are attached to the middle segment at a hinge 40. The hinges may be actuated to fold up or fold down the end segments. Devices 42 similar to alignment devices may be used to actuate the hinges, such as hydraulic cylinders.

The end segments, called wings, may be folded upward to lift the connected working unit bars and working units off the ground for storage. To prevent working unit damage, the alignment devices located on the wings are preferably placed in the storage mode prior to the folding up of the wings. Also, preferably, the alignment devices located on the wings are placed in the operational mode after the wings of the toolbar have been unfolded or lowered.

On each toolbar segment, there maybe exterior working unit bars and interior working unit bars. Exterior working unit bars are those located at either end of the segment. The interior working bars are those located on the toolbar segment between the exterior working unit bars.

Preferably, for exterior working unit bars, only a single alignment device is associated with each of these working unit bars, and the alignment device is located on the toolbar segment between the exterior working unit bar and the adjacent interior working unit bar. In this manner, the number of alignment devices can be minimized, while the damage to adjacent working units from uncontrolled movement of the working unit bars can be also minimized. Conversely, for interior working unit bars, two alignment devices are associated with each of the working unit bars, one on either side of the joint for that particular working unit bar. Here, use of two alignment devices further restricts the movement of the interior working unit bars and working units to minimize damage to working units by controlling the free movement of the working unit bars.

In one embodiment, the implement further comprises a mechanism for raising and lowering the toolbar (and any segments) as a whole relative to the ground so that the working units do not contact the ground, and thus placing the whole toolbar into storage mode. Preferably the alignment devices are extended prior to the raising of the toolbar, so that they are in storage mode prior to raising the toolbar.

In addition to the alignment devices, the invention may also include controls and systems for operation of the alignment devices, that permit control and operation of the alignment devices remotely, such as by the operator on the implement or an operator remote from the implement. Such controls may be wireline or wireless and use any appropriate communications protocol. Such systems include hydraulic systems that provide pressure through hydraulic fluids to the alignment devices and the like.

It will be further appreciated that functions or structures of a plurality of components or steps may be combined into a single component or step, or the functions or structures of one-step or component may be split among plural steps or components. The present invention contemplates all of these combinations. Unless stated otherwise, dimensions and geometries of the various structures depicted herein are not intended to be restrictive of the invention, and other dimensions or geometries are possible. Plural structural components or steps can be provided by a single integrated structure or step. Alternatively, a single integrated structure or step might be divided into separate plural components or steps. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention. The present invention also encompasses intermediate and end products resulting from the practice of the methods herein. The use of “comprising” or “including” also contemplates embodiments that “consist essentially of” or “consist of” the recited feature.

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the invention. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes.

What is claimed is:

1. A device comprising:
at least one working unit bar attached to a toolbar at a joint, wherein the joint has at least one axis of rotation;
for each working unit bar, at least one alignment device comprising a storage mode and an operational mode;
wherein, in the storage mode, the at least one alignment device impinges on the working unit bar or the toolbar, and wherein, in the operational mode, the at least one alignment device permits the working unit bar to freely rotate about the at least one axis of rotation and the at least one axis of rotation is perpendicular to the ground.

2. The device of claim 1 wherein the at least one alignment device is a ram alignment device or a lever alignment device.

3. The device of claim 2 wherein the at least one alignment device is a ram alignment device that has a length that is longer in storage mode than in operational mode.

4. The device of claim 3 further comprising a plurality of working unit bars, each attached to the toolbar by a single axis pivot.

5. The device of claim 4 further comprising a plurality of alignment devices, wherein at least one of the plurality of alignment devices is associated with each of the plurality of working unit bars.

6. The device of claim 5 wherein exterior working unit bars are associated with a single alignment device, and wherein interior working unit bars are associated with two alignment devices.

7. The device of claim 6 further comprising a toolbar having at least three toolbar segments.

8. The device of claim 7 wherein all of the plurality of alignment devices are simultaneously in storage mode or simultaneously in operational mode.

9. The device of claim 2 wherein each working unit bar comprises at least one mounting plate, and wherein, in the storage mode, the at least one alignment device impinges on the mounting plate.

10. The device of claim 9 wherein each working unit bar comprises at least one stop that restricts the movement of the working unit bar about the joint when in operational mode.

11. A method of operating an agricultural implement, comprising:
actuating at least one alignment device to impinge or release at least one working unit bar or at least one toolbar, wherein the at least one working unit bar is connected to the at least one toolbar at a joint, wherein impinging the at least one working unit bar or the at least one toolbar prevents the at least one working unit bar from moving about the joint, and wherein releasing the at least one working unit bar permits the at least one working unit to move about the joint.

12. The method of claim 11 wherein the at least one working unit bar is connected to the at least one toolbar by a single axis pivot.

13. The method of claim 12 wherein in the actuating step comprises extending the at least one alignment device or retracting the at least one alignment device.

14. The method of claim 13 wherein extending the at least one alignment device increases the length of the at least one alignment device and wherein retracting the at least one alignment device decreases the length of the at least one alignment device.

15. The method of claim 14 wherein the at least one alignment device is connected to the at least one toolbar and impinges the at least one working unit bar at a mounting plate.

16. The method of claim 12 wherein the actuating step comprises simultaneously extending or retracting each of at least one alignment devices.

17. The method of claim 13 further comprising actuating at least one device to fold up or fold down at least one segment of the toolbar.

18. The method of claim 17 wherein the actuating of the at least one device to fold up or fold down at least one segment occurs after extending the at least one alignment device.
